(19) United States
(12) Patent Application Publication
(10) Pub. No.: US 2026/0303714 A1
(43) Pub. Date: Oct. 1, 2026

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Yapu LI, Dongguan (CN); Ning GAO, Dongguan (CN); Chaoming LUO, Dongguan (CN); Liuming LU, Dongguan (CN); Jun ZHANG, Dongguan (CN)

(73) Assignee: GUANGDONG OPPO MOBILE TELECOMMUNICATIONS CORP., LTD., Dongguan (CN)

(21) Appl. No.: 19/696,835

(22) Filed: Jun. 3, 2026

Related U.S. Application Data
(63) Continuation of application No. PCT/CN2024/072027, filed on Jan. 12, 2024.

(51) Int. Cl. H04L 69/323; H04L 5/00

(52) U.S. Cl. CPC H04L 69/323; H04L 5/0007

(57) ABSTRACT

Provided are a wireless communication method and a communication device. The method includes: a first device sending a first PPDU to a second device, where the first PPDU includes a first user field of a first user, and the first user field carries UHR feature information. On the basis of the present application, a first device can indicate UHR feature information to a second device by means of a first user field in a first PPDU.

### CROSS-REFERENCE TO RELATED APPLICATIONS

This application is a continuation of International Application No. PCT/CN2024/072027, filed on Jan. 12, 2024, the disclosure of which is hereby incorporated by reference in its entirety.

### TECHNICAL FIELD

This application relates to the field of communications technologies, and more specifically, to a wireless communication method and a communications device.

### BACKGROUND

With the development of wireless fidelity (Wi-Fi) technologies, a process of communication between an access point (AP) and a station STA) may involve an ultra-high reliability (UHR) feature. Therefore, it may be necessary for the AP and the STA to mutually indicate UHR feature information. However, it is not yet clear how the AP and the STA indicate UHR feature information.

### SUMMARY

This application provides a wireless communication method and a communications device. Various aspects of this application are described below.

According to a first aspect, a wireless communication method is provided, and the method includes: transmitting, by a first device, a first PPDU to a second device, where the first PPDU includes a first user field of a first user, and the first user field carries UHR feature information.

According to a second aspect, a wireless communication method is provided, and the method includes: receiving, by a second device, a first PPDU transmitted by a first device, where the first PPDU includes a first user field of a first user, and the first user field carries UHR feature information.

According to a third aspect, a communications device is provided. The communications device is a first device, and includes: a transmitting module, configured to transmit a first PPDU to a second device, where the first PPDU includes a first user field of a first user, and the first user field carries UHR feature information.

According to a fourth aspect, a communications device is provided. The communications device is a second device, and includes: a receiving module, configured to receive a first PPDU transmitted by a first device, where the first PPDU includes a first user field of a first user, and the first user field carries UHR feature information.

According to a fifth aspect, a communications device is provided and includes a memory and a processor, where the memory is configured to store a program, and the processor is configured to invoke the program in the memory, to cause the communications device to execute the method according to the first aspect.

According to a sixth aspect, a communications device is provided and includes a memory and a processor, where the memory is configured to store a program, and the processor is configured to invoke the program in the memory, to cause the communications device to execute the method according to the second aspect.

According to a seventh aspect, an apparatus is provided, including a processor configured to invoke a program from a memory, to cause the apparatus to execute the method according to the first aspect or the second aspect.

According to an eighth aspect, a chip is provided, including a processor configured to invoke a program from a memory, to cause a device installed with the chip to execute the method according to the first aspect or the second aspect.

According to a ninth aspect, a computer-readable storage medium is provided, where the computer-readable storage medium stores a program, and the program causes a computer to execute the method according to the first aspect or the second aspect.

According to a tenth aspect, a computer program product is provided, including a program, where the program causes a computer to execute the method according to the first aspect or the second aspect.

According to an eleventh aspect, a computer program is provided, where the computer program causes a computer to execute the method according to the first aspect or the second aspect.

### BRIEF DESCRIPTION OF DRAWINGS

FIG. 1 is a schematic structural diagram of a wireless communications system to which embodiments of this application are applicable.

FIG. 2 is a schematic structural diagram of an EHT MU PPDU.

FIG. 3 is a schematic structural diagram of an EHT-SIG content channel used for OFDMA transmission.

FIG. 4 is a schematic structural diagram of a 2D A-PPDU.

FIG. 5 is a schematic structural diagram of a DL OFDMA MU PPDU.

FIG. 6 is an example diagram of Inter-PPDU LPL.

FIG. 7 is a schematic flowchart of a wireless communication method according to an embodiment of this application.

FIG. 8 is a schematic structural diagram of a first PPDU according to an embodiment of this application.

FIG. 9 is a schematic structural diagram of a UHR-SIG according to an embodiment of this application.

FIG. 10 is a schematic structural diagram of a UHR-SIG according to another embodiment of this application.

FIG. 11 is a schematic structural diagram of a UHR-SIG according to another embodiment of this application.

FIG. 12 is a schematic structural diagram of a UHR-SIG according to another embodiment of this application.

FIG. 13 is a schematic diagram of a structure of a communications device according to an embodiment of this application.

FIG. 14 is a schematic diagram of a structure of a communications device according to another embodiment of this application.

FIG. 15 is a schematic diagram of a structure of a communications apparatus according to an embodiment of this application.

### DESCRIPTION OF EMBODIMENTS

Technical solutions in this application are described below with reference to the accompanying drawings.

### Communications System

The technical solutions in embodiments of this application may be applied to various communications systems, for example, a wireless local area network (WLAN), Wi-Fi, a high performance radio local area network (HIPELAN), a wide area network (WAN), a cellular network, or another communications system. For another example, the technical solutions in embodiments of this application may be applied to a communications system using the 802.11 standard. For example, the 802.11 standard includes but is not limited to the 802.11ax standard, the 802.11be standard, a subsequent next generation 802.11 standard, or the like.

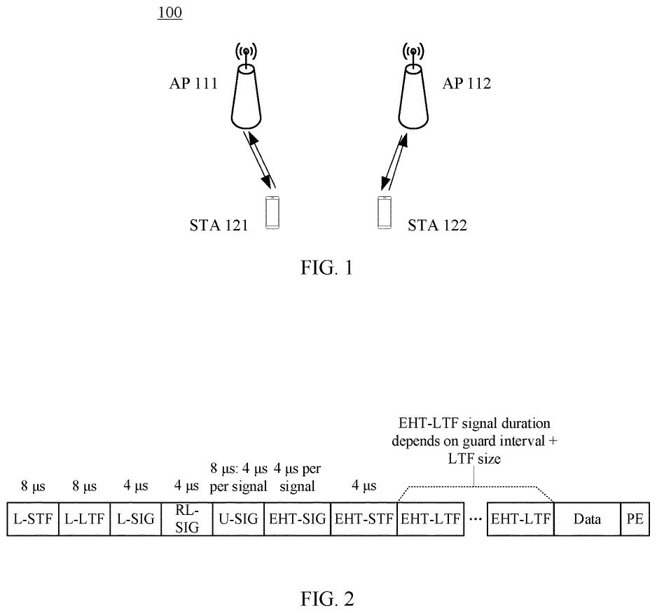

FIG. 1 is a schematic diagram of a communications system to which embodiments of this application are applied. Referring to FIG. 1, communications devices in a communications system 100 may include an access point (AP) 111, an AP 112, a station (STA) 121, and a STA 122, where the STA 121 may access a network via the AP 111, and the STA 122 may access a network via the AP 112.

In some implementations, a STA may establish an association relationship with one or more APs. Then, the STA and the AP(s) that have an association relationship may communicate with each other. With reference to FIG. 1, the AP 111 and the STA 121 may communicate with each other after an association relationship is established therebetween; and the AP 112 and the STA 122 may communicate with each other after an association relationship is established therebetween.

In some implementations, communication in the communications system 100 may be communication between an AP and a non-AP STA, or may be communication between one non-AP STA and another non-AP STA, or may be communication between a STA and a peer STA, where the peer STA may refer to a device that performs peer-to-peer communication with the STA, for example, the peer STA may be an AP, or may be a non-AP STA.

It should be understood that FIG. 1 exemplarily shows two AP STAs and two non-AP STAs. Alternatively, the communications system 100 may include more AP STAs, or the communications system 100 may include another quantity of non-AP STAs. This is not limited in embodiments of this application.

In addition, the communications system may be applied to scenarios of multi-device collaboration, for example, a scenario of multiple AP (Multi-AP) collaboration, a scenario of multi-station collaboration, or the like.

Names the AP and/or STA are not limited in embodiments of this application. In some scenarios, an AP may also be referred to as an AP STA. That is, in a sense, the AP is also a STA. In some other scenarios, a STA may also be referred to as a non-AP STA.

In some scenarios, the foregoing communications device may alternatively be a “multi-link device (MLD)”, namely, a device that may perform communication through a plurality of communications links. The plurality of communications links may include communications links of different frequency bands, for example, may include a millimeter-wave frequency band and/or a low frequency band. Generally, if the multi-link device is an AP, the AP may also be referred to as a “multi-link AP”; if the multi-link device is a STA, the STA may also be referred to as a “multi-link STA”.

In embodiments of this application, the AP may be a device in a wireless network. The AP may be a communications entity, for example, a communications server, a router, a switch, a network bridge, or the like; or the AP device may include various forms of macro base stations, micro base stations, relay stations, or the like. Certainly, the AP may alternatively be a chip, a circuit, or a processing system in these various forms of devices, to implement a method and a function in embodiments of this application. The AP device may be applied to a variety of scenarios, for example, a sensor node in a smart city (for example, a smart water meter, a smart electricity meter, or a smart air detection node), a smart device in a smart home (for example, a smart camera, a projector, a display screen, a TV, a speaker, a refrigerator, a washing machine, or the like), a node in the Internet of Things, an entertainment terminal (for example, a wearable device such as AR or VR), a smart device in a smart office (for example, a printer, a projector, or the like), a vehicle-to-everything device in the Internet of Vehicles, some infrastructure in daily life scenarios (for example, a vending machine, a self-service navigation station in a shopping mall or supermarket, a self-service cashier device, or a self-ordering kiosk), or the like.

In some implementations, a role of the STA in the communications system is not fixed. In some scenarios, the STA may serve as an AP. For example, in a scenario in which a mobile phone is connected to a route, the mobile phone may be a non-AP STA; in a case that the mobile phone serves as a hotspot of another mobile phone, the mobile phone acts as an AP.

In embodiments of this application, a STA in embodiments of this application may be a device having a wireless transceiver function, for example, may be a device that supports protocols 802.11 series and may communicate with an AP or another STA. For example, the STA is any user communications device that allows a user to communicate with an AP and then communicate with WLAN. The STA is, for example, a user equipment (UE), a mobile station (MS), a mobile terminal (MT), an access terminal, a subscriber unit, a subscriber station, a mobile site, a mobile station, a remote station, a remote terminal, a mobile device, a user terminal, a terminal, a wireless communications device, a user agent, a user apparatus, or the like.

The STA in embodiments of this application may alternatively be a device providing a user with voice/data connectivity, for example, a handheld device, a vehicle-mounted device, or the like having a wireless connection function. For example, the STA is a mobile phone, a tablet computer, a notebook computer, a palmtop computer, a mobile Internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a future 5G network, a terminal device in a future evolved public land mobile network (PLMN), or the like. This is not limited in embodiments of this application.

By way of example rather than limitation, in embodiments of this application, the STA may alternatively be a wearable device. The wearable device may also be referred to as a wearable intelligent device, and is a general term for wearable devices such as glasses, gloves, watches, clothes, and shoes that are intelligently designed and developed by applying wearable technologies to daily wearing. For example, the wearable device is a smart watch or smart glasses, or a device that focuses on only a specific type of application function and is required to cooperate with another device such as a smart phone for use, for example, various smart bracelets, smart jewelries, or the like for physical sign monitoring.

In addition, in embodiments of this application, the STA may alternatively be a terminal device in an Internet of Things (IoT) system. The IoT is an important component of future development of information technologies, and a main technical feature of the IoT is that objects are connected to a network by using a communication technology, to implement an intelligent network of human-computer interconnection and interconnection of things. In embodiments of this application, the IoT technology may implement mass connection, intensive coverage, and terminal power saving by using a narrow band (NB) technology or the like.

In addition, in embodiments of this application, the STA may be a device in a vehicle-to-everything system. Communication methods in the vehicle-to-everything system are collectively referred to as V2X (where X represents everything). For example, the V2X communication includes: vehicle to vehicle (V2V) communication, vehicle to roadside infrastructure (V2I) communication, vehicle to pedestrian (V2P) communication, vehicle to network (V2N) communication, or the like.

In addition, in embodiments of this application, the STA may further include sensors such as a smart printer, a train detector, a gas station, or the like. Main functions of the device include: data collection (some terminal devices), receiving of control information and downlink data of the AP device, transmitting of an electromagnetic wave, and transmission of data to the AP.

In addition, the AP device in embodiments of this application may be a device for communicating with the STA device. The AP device may be a network device in a wireless local area network. The AP device may be configured to communicate with the STA device through the wireless local area network.

From the perspective of a communication standard supported by an AP, in some implementations, the AP may be a device that supports the 802.11be standard. The AP may alternatively be a device that supports a plurality of current and future WLAN standards of the 802.11 family, such as 802.11ax, 802.11ac, 802.11n, 802.11g, 802.11b, and 802.11a.

From the perspective of a communication standard supported by a STA, in some implementations, the non-AP STA may support the 802.11be standard. The non-AP STA may also support a plurality of existing and future wireless local area network (WLAN) standards of an 802.11 family, such as 802.11ax, 802.11ac, 802.11n, 802.11g, 802.11b, and 802.11a.

Frequency bands supported in a WLAN technology are not limited in embodiments of this application. In some implementations, the frequency bands supported in the WLAN technology may include but are not limited to a low frequency band (for example, 2.4 GHz, 5 GHZ, or 6 GHz) and a high frequency band (for example, 45 GHz or 60 GHz).

It should be understood that specific forms of the STA and the AP device are not specially limited in embodiments of this application and are only described exemplarily herein.

### Extremely High Throughput (EHT)-Signal (SIG) Field

In communication between an AP and a STA, an EHT multi-user (MU) physical layer protocol data unit (PPDU) may be used for data transmission of one or more users. A format of the EHT MU PPDU may be as shown in FIG. 2. A non-high-throughput (non-HT)-short training field (STF), a non-high-throughput long-training field (L-LTF), a non-high-throughput-signal field (L-SIG), a repeated non-high-throughput-signal field (RL-SIG), a universal-signal field (U-SIG), and an EHT-SIG field may be referred to as pre-EHT modulated fields; and an EHT-STF, an EHT-LTF, a data and a packet extension (PE) field may be referred to as EHT modulated fields.

The EHT-SIG field may provide additional signaling to the U-SIG field for the STA to decode the EHT MU PPDU. In the EHT MU PPDU, the EHT-SIG field may include U-SIG overflow bits common to all users. The EHT-SIG field may further include resource unit (RU) allocation information, allowing the STA to find a corresponding resource used in an EHT modulated field of a PPDU.

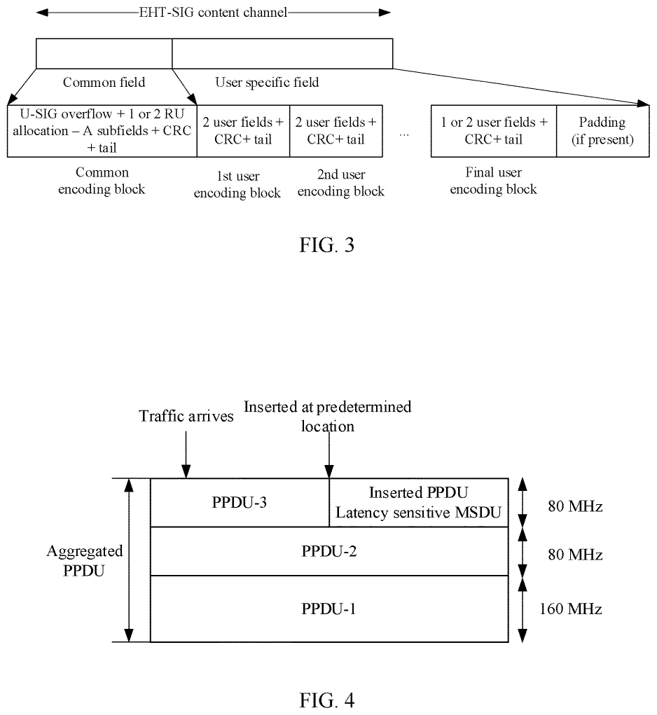

An EHT-SIG field of a 20-megahertz (MHz) EHT MU PPDU may include one EHT-SIG content channel. For orthogonal frequency division multiple access (OFDMA) transmission and multi-user non-OFDMA transmission, an EHT-SIG field of a 40-MHz or 80-MHz EHT MU PPDU includes two EHT-SIG content channels. For OFDMA transmission and multi-user non-OFDMA transmission, an EHT-SIG field of a 160-MHz or wider EHT MU PPDU includes two EHT-SIG content channels per 80-MHz frequency sub-block. When a bandwidth of an EHT MU PPDU used for OFDMA transmission is greater than 80 MHz, the EHT-SIG content channel in each 80-MHz frequency sub-block is allowed to carry different information. When the bandwidth is equal to 20/40/80 MHz, a format of an EHT-SIG content channel used for OFDMA transmission may be as shown in FIG. 3.

For OFDMA transmission, a common field of the EHT-SIG content channel includes information about RU allocation, such as RU allocation used in an EHT modulated field of the PPDU, an RU allocated for MU-multiple input multiple output (MIMO), and a quantity of users allocated for MU-MIMO. A format of the common field may be as shown in Table 1.

TABLE 1
Format of common field for OFDMA transmission

| | | | Number of | |
|---|---|---|---|---|
| | | Number of | bits per | |
| Bit | Subfield | subfields | subfield | Description |
| B0-B3 | Spatial reuse | 1 | 4 | Indicates whether or not spatial reuse |
| | | | | modes are allowed during the transmission |
| | | | | of this PPDU. |
| B4-B5 | Guard interval | 1 | 2 | Indicates the guard interval and LTF size. |
| | (GI) + LTF size | | | |
| B6-B8 | Number of | 1 | 3 | Indicates the number of EHT-LTF symbols. |
| | EHT-LTF | | | |
| | symbols | | | |
| B9 | Low density | 1 | 1 | Indicates the presence of the low density |
| | parity check | | | parity check code extra symbol segment. |
| | code (LDPC) | | | |
| | extra symbol | | | |
| | segment | | | |
| B10-B11 | Pre-forward | 1 | 2 | Indicates the pre-forward error correction |
| | error correction | | | padding factor. |
| | (FEC) | | | |
| | padding factor | | | |
| B12 | PE disambiguity | 1 | 1 | Indicates PE disambiguity. |
| B13-B16 | Disregard | 1 | 4 | Set to all 1s. |
| B17-B16 + 9N | RU allocation-A | N | 9 | Each RU allocation-A subfield in |
| | | | | an EHT-SIG content channel |
| | | | | corresponding to a 20 MHz frequency |
| | | | | subchannel indicates the RU or MRU |
| | | | | assignment, including the size of the |
| | | | | RU(s) or MRU(s) and their placement |
| | | | | in the frequency domain, to be used in |
| | | | | the EHT modulated fields of the EHT |
| | | | | MU PPDU in the frequency domain. |
| | | | | Each RU allocation-A subfield also |
| | | | | indicates information needed to |
| | | | | compute the number of users allocated |
| | | | | to each of these RU(s) or MRU(s). |
| B17 + 9N- | Cyclic | 1 | 4 | The CRC is calculated over bits 0 to |
| B20 + 9N | redundancy | | | 16 + 9N. |
| | check (CRC) | | | |
| B21 + 9N- | Tail | 1 | 6 | Used to terminate the trellis of the |
| B26 + 9N | | | | convolutional decoder. Set to 0. |
| B27 + 9N- | RU allocation-B | M | 9 | RU allocation-B subfields are present |
| B26 + 9N + 9M | | | | in an EHT-SIG content channel if the |
| | | | | bandwidth subfield in the U-SIG field |
| | | | | indicates a 160 MHz, 320 MHz − 1, or 320 |
| | | | | MHz − 2 EHT MU PPDU where M is |
| | | | | equal to 2 or 6 as follows: |
| | | | | M is set to 2 if the bandwidth field in |
| | | | | the U-SIG field is 3. |
| | | | | M is set to 6 if the bandwidth field in |
| | | | | the U-SIG field is 4 or 5. |
| | | | | The subfields are not present otherwise |
| | | | | (i.e., M is equal to 0). |
| | | | | Each RU allocation-B subfield in an |
| | | | | EHT-SIG content channel |
| | | | | corresponding to a 20 MHz frequency |
| | | | | subchannel indicates the RU or MRU |
| | | | | assignment, including the size of the |
| | | | | RU(s) or MRU(s) and their placement |
| | | | | in the frequency domain, to be used in |
| | | | | the EHT modulated fields of the EHT |
| | | | | MU PPDU in the frequency domain. |
| | | | | Each RU allocation-B subfield also |
| | | | | indicates information needed to |
| | | | | compute the number of users allocated |
| | | | | to each of these RU(s) or MRU(s). |
| B27 + 9N + 9M- | CRC | 0 or 1 | 4 | The CRC subfield is present if the |
| B30 + 9N + 9M | | | | bandwidth subfield in the U-SIG field |
| | | | | indicates a 160 MHz, 320 MHz − 1, or |
| | | | | 320 MHz − 2 EHT MU PPDU and not |
| | | | | present otherwise. |
| | | | | If present, the CRC is calculated over |
| | | | | 27 + 9N to 26 + 9N + 9M. |
| B31 + 9N + 9M- | tail | 0 or 1 | 6 | The tail subfield is present if the |
| B36 + 9N + 9M | | | | bandwidth subfield in the U-SIG field |
| | | | | indicates a 160 MHz, 320 MHz − 1, or |
| | | | | 320 MHz − 2 EHT MU PPDU and not |
| | | | | present otherwise. |
| | | | | If present, then it is used to terminate |
| | | | | the trellis of the convolutional decoder. |
| | | | | Set to 0. |

A union of the user specific field in the EHT-SIG content channel includes information for all users in the PPDU regarding how to decode its payload. As shown in FIG. 3, the user specific field includes user encoding blocks, and the user encoding blocks include user fields for OFDMA transmission.

The user specific field in the EHT-SIG content channel may include zero or more user encoding blocks, followed by padding bits (if present). A format of the user encoding blocks may be as shown in Table 2.

TABLE 2
Format of user encoding blocks

| | | | Number of | |
|---|---|---|---|---|
| | | Number of | bits per | |
| Bit | Subfield | subfields | subfield | Description |
| B0- | user | N | 22 | User fields are present, where: |
| B22N − 1 | field | | | N = 1 if it is the final user encoding block, and if |
| | | | | there is only one user in the final user encoding |
| | | | | block. |
| | | | | N = 2 otherwise. |
| B22N- | CRC | 1 | 4 | The CRC is calculated over bits 0 to 21 for a user |
| B22N + 3 | | | | encoding block that includes one user field, |
| | | | | and bits 0 to 43 for a user encoding block that |
| | | | | includes two user fields. |
| B22N + 4- | tail | 1 | 6 | Used to terminate the trellis of the convolutional |
| B22N + 9 | | | | decoder. Set to 0. |

Content of the user field depends on whether an address of the field is a user allocated in an RU for non-MU-MIMO or a user allocated in an RU for MU-MIMO. When the address of the field is a user allocated in an RU for non-MU-MIMO, the content of the user field may be as shown in Table 3. When the address of the field is a user allocated in an RU for MU-MIMO, a format of the user field may be as shown in Table 4.

TABLE 3
User field format for a non-MU-MIMO allocation

| | | Number of | |
|---|---|---|---|
| Bit | Subfield | subfields | Description |
| B0-B10 | STA-identity (ID) | 11 | Set to a value of the transmit vector |
| | | | (TXVECTOR) parameter STA-ID. |
| B11-B14 | Modulation and | 4 | Set to n for EHT-MCS n, where n = 0, 1, . . . , 15. |
| | coding scheme | | |
| | (MCS) | | |
| B15 | Reserved | 1 | Reserved and set to 1. |
| B16-B19 | Number of spatial | 4 | Set to the number of spatial streams minus 1. |
| | streams (NSS) | | |
| B20 | Beamformed | 1 | Set to 1 if a beamforming steering matrix is |
| | | | applied to the waveform in a non-MU-MIMO |
| | | | allocation. |
| | | | Set to 0 otherwise. |
| B21 | Coding | 1 | Indicates whether information block check |
| | | | character (BCC) or LDPC is used: |
| | | | Set to 0 for BBC. |
| | | | Set to 1 for LDPC. |

TABLE 4
User field format table for an MU-MIMO allocation

| | | Number of | |
|---|---|---|---|
| Bit | Subfield | subfields | Description |
| B0-B10 | STA-ID | 11 | Set to a value of the TXVECTOR parameter STA-ID. |
| B11-B14 | MCS | 4 | Set to n for EHT-MCS n, where n = 0, 1, . . . , 15. |
| B15 | coding | 1 | Indicates whether information block check character |
| | | | (BCC) or low density parity check code (LDPC) is |
| | | | used: |
| | | | Set to 0 for BBC. |
| | | | Set to 1 for LDPC. |
| B16-B21 | Spatial | 6 | Indicates the number of spatial streams for a user in |
| | configuration | | an MU-MIMO allocation |

### Two Dimensional (2D) Frequency Domain (FD) Aggregated (A)-PPDU

For latency sensitive services, a 2D A-PPDU is proposed in a related technology. In the 2D A-PPDU, RUs for downlink transmission may be allocated not only in frequency domain but also in time domain, so that as many latency sensitive medium access control service data units (MSDU) are transmitted as possible on an on-going PPDU, thereby reducing latency.

Requirements for inserting latency sensitive MSDUs into a PPDU may include: (1) Transparency to a legacy STA, including 11be release 1; (2) Transmit as many latency sensitive MSDUs as possible on the on-going PPDU (including FD A-PPDU) to reduce latency; and (3) use only a necessary sub-channel, and considering that latency sensitive traffic is generally small, using an entire 320-MHz PPDU is quite wasteful.

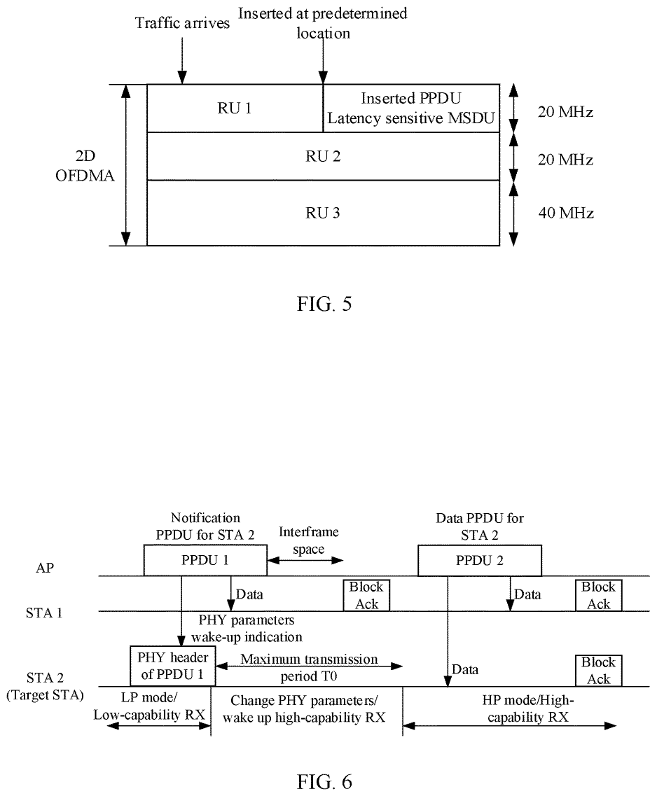

Considering these requirements, a structure of a 2D FD A-PPDU may be as shown in FIG. 4. To reduce complexity of a receiver for a latency sensitive MSDU, a latency sensitive MSDU may be transmitted based on a start time of a slot. For example, a fixed number of OFDM symbols may be defined for transmission of the latency sensitive MSDU for a potential start 2D FD A-PPDU. For example, as shown in FIG. 5, a fixed number of OFDM symbols may alternatively be defined in a downlink (DL) OFDMA MU PPDU for transmitting a latency sensitive MSDU.

### Low Power Listening (LPL) for Inter-Basic Service Set (BSS) PPDU (Also Referred to as Inter-PPDU)

Low power (LP) mode generally uses one radio frequency link, low-order MCS, and a small bandwidth; and high power (HP) mode uses a plurality of radio frequency links, high-order MCS, and a bandwidth up to 320 MHz, which varies significantly when duration of different physical (PHY) parameters changes. A related technology proposes an LPL scheme for an inter-PPDU to reduce both power consumption and signaling overheads. The LPL scheme for the inter-PPDU may be as shown in FIG. 6, including an initial PPDU (namely, a notification PPDU) for waking up a target STA, and subsequent PPDUs (namely, data PPDUs) for delivering data of the target STA. An interval between the notification PPDU and the first data PPDU provides sufficient duration for changing a PHY parameter/function.

In an LPL process, the target STA initially adopts a dedicated LP mode for listening. Once a wake-up indication is detected, the target STA begins switching to an HP mode. In the LPL scheme for the inter-PPDU, an AP may transmit an initial PPDU (namely, a notification PPDU) to wake up the target STA. The notification PPDU may indicate a PHY parameter received in the HP mode, which may also include a wake-up indication or an indication of upcoming data. For example, different PHY parameters that are detected may be considered the wake-up indication. The notification PPDU is mainly used to transmit data to another STA, and subsequent PPDUs (namely, data PPDUs) are used to transmit data to the target STA.

Based on the foregoing description, a process of communication between the AP and the STA may involve UHR features such as LPL for a 2D FD A-PPDU and an inter-PPDU. Therefore, it may be necessary for the AP and the STA to mutually indicate UHR feature information. For example, when performing time domain resource allocation for different latency sensitive MSDUs in the 2D FD A-PPDU, the AP needs to further indicate a time domain resource unit to each STA. For another example, in the LPL for the inter-PPDU, where the AP needs to indicate, in the notification PPDU, a PHY parameter for the target STA to enter high power. However, it is not yet clear how the AP and the STA indicate UHR feature information.

Based on this, the following describes in detail the method in embodiments of this application.

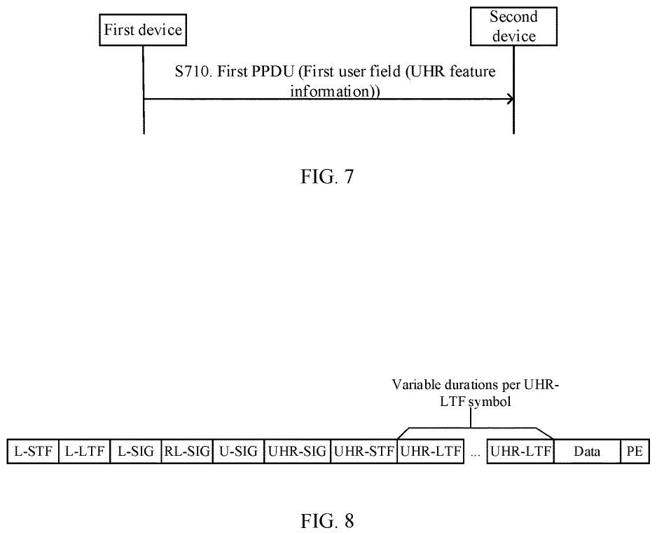

As shown in FIG. 7, an embodiment of this application provides a wireless communication method. The method shown in FIG. 7 is applicable to any AP and/or STA described above. For ease of understanding, devices to which the method is applicable are represented by a first device and a second device below. In embodiments of this application, the first device may be an AP, and the second device may be a STA. In embodiments of this application, the first device may be a STA, and the second device may be an AP.

The method illustrated in FIG. 7 may include step S710. In step S710, the first device transmits a first PPDU to the second device. The first PPDU may include a first user field of a first user, and the first user field may carry UHR feature information. The UHR feature information may be related information used between the first device and the second device to implement a UHR feature. When the first device is a STA and the second device is an AP, the first PPDU may be a PPDU in an uplink transmission process, such as an uplink MU PPDU single user (SU) transmission mode. Alternatively, when the first device is an AP and the second device is a STA, the first PPDU may be a PPDU in a downlink transmission process, such as a downlink OFDMA MU PPDU.

Based on this application, the first device may indicate the UHR feature information to the second device through the first user field in the first PPDU, which helps implement a UHR feature in communication between the first device and the second device.

The first user field is described in detail below. As mentioned above, the user field in the EHT-SIG field of the PPDU shown in FIG. 3 may be used to indicate related information for each user. However, as shown in Table 3 or Table 4, there are few available reserved bits in the user field, only one or even no reserved bits. However, the UHR feature information may occupy more than one bit, so it is difficult to use the user field of the EHT-SIG field to carry the UHR feature information. Based on this, in this application, the UHR feature information may be carried in the first user field.

The first user field may not include subfields, and then the UHR feature information may be carried by the first user field itself. For example, the first user field may be a field that is expanded based on the user field in the EHT-SIG field, that is, a specific number of bits may be added to the user field in the EHT-SIG field to carry the UHR feature information. In this case, a number of bits of the first user field is greater than 22 bits; for example, the number of bits of the first user field may be 30 bits. Carrying the UHR feature information in the first user field itself helps reduce decoding overheads of the second device.

Alternatively, the first user field may include a subfield, and then the UHR feature information may be carried in the subfield. For example, the first user field may include a second user field and a third user field. The second user field may be used to carry fundamental information of the first user. For example, the second user field may be the user field described above. The third user field may then be used to carry the UHR feature information, and there may be one or more third user fields. For example, the third user field may be a newly added subfield beyond the user field described above. Carrying the UHR feature information in the subfield of the first user field helps the second device quickly locate the UHR feature information.

The third user field is described in detail below. In the first user field, the third user field may be located after the second user field, and the third user field may be adjacent to the second user field, which helps the first user quickly locate the third user field. Further, the third user field may have the same number of bits as the second user field. For example, when the second user field is the user field described above, a number of bits of both the second user field and the third user field is 22 bits. In this case, the number of bits of the first user field is also greater than 22 bits.

The first n bits of the third user field may be used to indicate a first identity, and the first identity may be used to indicate the first user. The first n bits of the second user field may also be used to indicate a second identity, and the second identity may also be used to indicate the first user, and the second identity is the same as the first identity. That is, the first n bits of the third user field and the first n bits of the second user field may be used to indicate an identity of a same user, that is, the third user field and the second user field may be fields for a same user. For example, a value of n may be 11, and the first identity and the second identity may be STA-ID. Based on this, it helps the first user quickly locate its corresponding third user field. The second user field and the third user field may be located in a same user encoding block, which helps the first user quickly locate the third user field.

Further, the first PPDU may further include a first field, and the first field may be used to indicate whether the first user field carries a third user field, which helps the first user determine whether the first user needs to find its corresponding third user field. For example, the first field may occupy one bit in the first PPDU. When a value of the first field is a first value, it may indicate that the first user field carries a third user field. When a value of the first field is a second value, it may indicate that the first user field does not carry a third user field. For example, the first value may be 1, and the second value may be 0. Alternatively, the first value may be 0, and the second value may be 1.

In some implementations, the first field may be located in the second user field. For example, when the second user field is the user field described above, the first field may occupy one bit in the user field described above. For example, the first field may occupy the reserved bit in the user field described above.

In some other implementations, the first PPDU may further include a first common field, and the first field may be located in the first common field. For example, the first common field may be the common field shown in Table 1, and the first field may occupy one bit in the common field shown in Table 1. For example, the first field may occupy the 13th bit of the common field described above.

The first field may be identified by the second device based on a resource preemption function of the second device. That is, the second device with the resource preemption function may identify the first field and then attempt to find one or more third user fields corresponding to the second device. A second device without the resource preemption function may not identify the first field and thus not attempt to find one or more third user fields corresponding to the second device, which helps reduce decoding overheads of such second devices. The resource preemption function of the second device may be determined based on first information of the second device, and the first information may be maintained by a management entity of the second device. For example, the first information may be management information base (MIB) information or management information set information of the second device, such as dot 11 preemption option implemented (dot11PreemptionOptionImplemented) information. When a value of the first information is a first value, it may indicate that the second device supports the resource preemption function. When a value of the first information is a second value, it may indicate that the second device does not support the resource preemption function. For example, the first value may be true, and the second value may be false. For example, the first information may be maintained by a station management entity (SME) of the second device.

The UHR feature information in the first user field is described in detail below.

The UHR feature information may include a first time domain resource quantity, the first time domain resource quantity may be a quantity of OFDM symbols occupied by a first service of the first user in a first time domain resource, and the first time domain resource may be a time domain resource divided in a first frequency-domain RU. The first frequency-domain RU may be a frequency-domain RU in a first PPDU, and the first frequency-domain RU may correspond to the first user. That is, the first time domain resource quantity is a quantity of time domain resources allocated for a first service in the first frequency-domain RU. Based on the first time domain resource quantity, the first device or the second device may preferentially occupy a corresponding quantity of OFDM symbols in the first time domain resource for transmission of the first service, which helps reduce transmission latency of the first service.

Furthermore, the first time domain resource quantity may be determined based on a second field. That is, the first user field may carry the second field to indicate the first time domain resource quantity. The second field may occupy L bits in the first user field, where L may be a positive integer less than a total number of bits of the first user field.

In some implementations, the second field may be used to indicate a first value n, and the first value n may be used to indicate a multiple of the first time domain resource quantity relative to a second value M. In this case, the first time domain resource quantity may be determined based on a product n×M of the first value n and the second value M, and the product n×M may be used to indicate a quantity of first n×M OFDM symbols occupied by the first service in the first time domain resource, or the product n×M may be used to indicate a quantity of last n×M OFDM symbols occupied by the first service in the first time domain resource. Herein, the second value M is a positive integer. For example, the second value M may be 5, 10, or 20. The second value M may be predefined by a protocol or pre-configured, or the second value M may be negotiated and determined by the first device and the second device. The second field may be used to indicate a multiple of the first time domain resource quantity relative to the second value M, which helps reduce an amount of information in the second field.

In some other implementations, the second field may be used to indicate a first value n and a second value M. The first value n may be used to indicate that the first service is in the n^{th} time domain resource, and the second value M may be used to indicate a quantity of OFDM symbols in each time domain resource. In this case, the second device may determine a quantity of time resources based on a total quantity of OFDM symbols of the time resources and the second value M, and then locate a time domain resource in which the first service is located based on the first value n. The total quantity of OFDM symbols of the time domain resources may be obtained through an L-SIG field in the first PPDU. The first value n is a positive integer; for example, the first value n may be 1, 2, 3, or 4. The second value M is also a positive integer; for example, the second value M may be 5, 10, or 20. For example, the first value n may occupy 2 bits in the second field, and the second value M may occupy L−2 bits in the second field. For example, a value of bits for the first value n being 0 may indicate that the first value n is 1; a value of bits for the first value being 1 may indicate that the first value n is 2; a value of bits for the first value n being 2 may indicate that the first value n is 3; a value of bits for the first value n being 3 may indicate that the first value n is 4. Based on the first value n and the second value M, this helps the second device quickly determine the first time domain resource quantity.

In some other implementations, the second field may be used to indicate a first value n, and the first value n may be used to indicate that the first service is in the n^{th} time domain resource. The first time domain resource quantity may be determined based on the first value n and a second value M, where the second value M may be used to indicate a quantity of OFDM symbols in each time domain resource. In this case, the second device may determine a quantity of time domain resources based on a total quantity of OFDM symbols of the time domain resources and the second value M, and then locate a time domain resource in which the first service is located based on the first value n. The total quantity of OFDM symbols of the time domain resources may be obtained through an L-SIG field in the first PPDU. The first value n is a positive integer; for example, the first value n may be 1, 2, 3, or 4. The second value M is also a positive integer; for example, the second value M may be 5, 10, or 20. The second value M may be predefined by a protocol or pre-configured, or the second value M may be negotiated and determined by the first device and the second device. The second field may only indicate that the first service is in the n^{th} time domain resource, which helps reduce an amount of information carried by the first user field.

In some other implementations, the second field may be used to indicate a first value n, and the first value n is used to indicate a quantity of OFDM symbols in each time domain resource. The first time domain resource quantity may be determined based on the first value n and a second value M, where the second value M may be used to indicate that the first service is in the M^{th} time domain resource. In this case, the second device may determine a quantity of time domain resources based on a total quantity of OFDM symbols of the time domain resources and the first value n, and then locate a time domain resource in which the first service is located based on the second value M. The total quantity of OFDM symbols of the time domain resources may be obtained through an L-SIG field in the first PPDU. The second value M may be predefined by a protocol or pre-configured, or the second value M may be negotiated and determined by the first device and the second device. The second field may only indicate a quantity of OFDM symbols in each time domain resource, which helps reduce an amount of information carried by the first user field.

It should be noted that the first service may be a low latency service, then the low latency service may preferentially occupy a quantity of OFDM symbols corresponding to the first time domain resource quantity in the first time domain resource, and remaining OFDM symbols may be occupied by a non-low latency service. Alternatively, the first service may be a non-low latency service, then the non-low latency service may preferentially occupy a quantity of OFDM symbols corresponding to the first time domain resource quantity in the first time domain resource, and remaining OFDM symbols may be occupied by a low latency service.

The UHR feature information may further include a parameter corresponding to the low power listening mode, to facilitate the second device in switching listening modes. The parameter corresponding to the low power listening mode may be a parameter indicating that the second device enters a high power mode from the low power listening mode, such as high power bandwidth, MCS, or a quantity of spatial streams. The high power bandwidth may be used to indicate a bandwidth at which the second device enters the high power mode from the low power listening mode. For example, a field carrying the high power bandwidth (hereinafter referred to as a “high power bandwidth field”) may occupy 2 bits in the first user field. When a value of the high power bandwidth field is 0, it may indicate 40 MHz. When a value of the high power bandwidth field is 1, it may indicate 80 MHz. When a value of the high power bandwidth field is 2, it may indicate 160 MHz. When a value of the high power bandwidth field is 3, it may indicate 320 MHz.

In addition to the UHR feature information, the first user field may further carry fundamental information of the first user. The fundamental information of the first user may include STA-ID, MCS, spatial stream, encoding scheme, enabled beamforming parameter, or the like. For example, the first user field may further include a fundamental information field, and then the fundamental information of the first user may be carried in the fundamental information field.

A wireless communication method of embodiments of this application is described with examples below with reference to FIGS. 8 to 12. It should be noted that in FIGS. 8 to 12, an example in which the first device is an AP and the second device is a STA is used.

The first PPDU in the wireless communication method of embodiments of this application is described with examples below with reference to FIG. 8. For example, the first PPDU shown in FIG. 8 may be a UHR MU PPDU. In communication between an AP and a STA, a UHR MU PPDU may be used for transmission of one or more users. In the UHR MU PPDU, L-STF, L-LTF, L-SIG, RL-SIG, U-SIG, and UHR-SIG may be referred to as pre-UHR modulated fields, while UHR-STF, UHR-LTF, data field, and PE field may be referred to as UHR modulated fields.

The UHR-SIG field of a 20-MHz UHR MU PPDU may include one UHR-SIG content channel. For OFDMA transmission and multi-user non-OFDMA transmission, a UHR-SIG field of a 40-MHz or 80-MHz UHR MU PPDU may include two UHR-SIG content channels. For OFDMA transmission and multi-user non-OFDMA transmission, a UHR-SIG field of a 160-MHz or wider UHR MU PPDU may include two UHR-SIG content channels per 80-MHz frequency sub-block. When a bandwidth of a UHR MU PPDU used for OFDMA transmission is greater than 80 MHz, the UHR-SIG content channel in each 80-MHz frequency sub-block may be allowed to carry different information.

For example, a format of the UHR-SIG field may be the same as the format of the EHT-SIG shown in FIG. 3. The UHR-SIG content channel of the UHR-SIG field may include a common field and a user specific field. The user specific field may include one or more user encoding blocks and padding (if present), and the user encoding block may include one or more user fields.

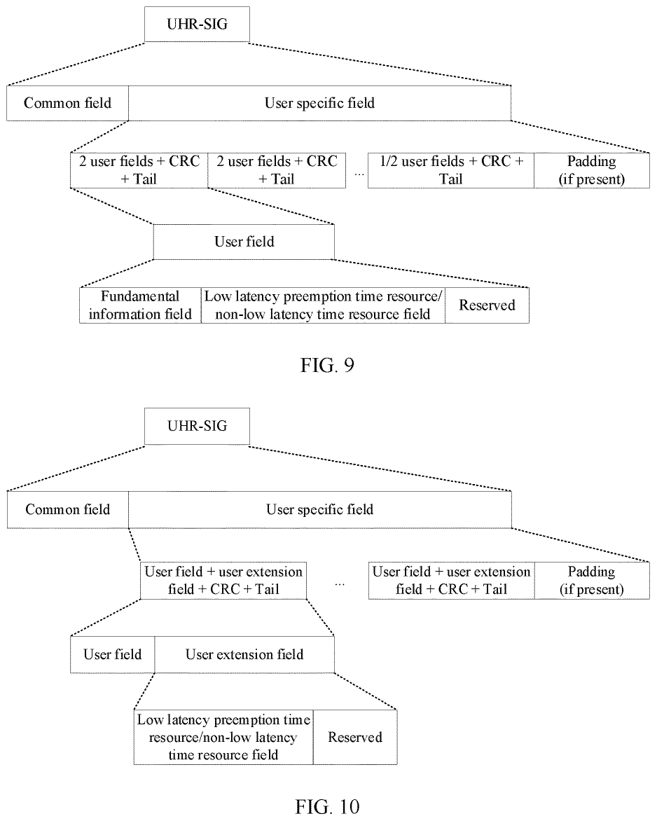

As mentioned above, the first PPDU may include a first user field. The first user field of the first PPDU in the wireless communication method of embodiments of this application is described with examples below with reference to FIGS. 9 and 10. For example, the first PPDU in FIGS. 9 and 10 may be the UHR MU PPDU shown in FIG. 8, and the first user field may be located in the UHR-SIG field of the UHR MU PPDU.

As shown in FIG. 9, the first user field is a user field that is expanded based on the user field in the UHR-SIG field, and UHR feature information may be carried in the first user field itself. In FIG. 9, in an example in which the UHR feature information is a first time domain resource quantity, the first time domain resource quantity may be determined based on a second field in the first user field. Referring to FIG. 9, the first user field may include a fundamental information field, a low latency preemption time resource/non-low latency time resource field, and a reserved bit. The fundamental information field may be used to carry fundamental information of a first user, such as STA-ID, MCS, quantity of spatial streams, encoding scheme, enabled beamforming parameter, or the like of the first user. The low latency preemption time resource/non-low latency time resource field is the second field, which may be used to carry a quantity of OFDM symbols occupied by a low latency service/non-low latency service in a first time domain resource. For example, a structure of the first user field in FIG. 9 may be as shown in Table 5 or Table 6, and a quantity of bits in the first user field may be N. The fundamental information field may occupy the first 22 bits, the low latency preemption time resource/non-low latency time resource field may occupy L fields located after the fundamental information field, and remaining bits may serve as reserved bits. A value of the low latency preemption time resource/non-low latency time resource field may be as described above and will not be repeated herein. It should be noted that the first user field in embodiments of this application may be formed by arranging and combining one or more subfields in Table 5 or Table 6. The arrangement and combination of subfields shown in Table 5 or Table 6 is one of multiple implementations of the first user field and constitutes no limitations on the first user field.

TABLE 5
First user field format for a non-MU-MIMO allocation

| | | Number of | |
|---|---|---|---|
| Bit | Subfield | subfields | Description |
| B0-B10 | STA-ID | 11 | For meaning, refer to Table 3; however, its |
| | | | implementation is not specifically limited. |
| B11-B14 | MCS | 4 | For meaning, refer to Table 3; however, its |
| | | | implementation is not specifically limited. |
| B15 | reserved | 1 | For meaning, refer to Table 3; however, its |
| | | | implementation is not specifically limited. |
| B16-B19 | NSS | 4 | For meaning, refer to Table 3; however, its |
| | | | implementation is not specifically limited. |
| B20 | beamformed | 1 | For meaning, refer to Table 3; however, its |
| | | | implementation is not specifically limited. |
| B21 | coding | 1 | For meaning, refer to Table 3; however, its |
| | | | implementation is not specifically limited. |
| B22 - | low latency | L | The low latency preemption time resource is used to |
| B21 + L | preemption | | indicate a first time domain resource quantity for a |
| | time | | latency sensitive service; |
| | resource (or | | the non-low latency time resource is used to indicate a |
| | non-low | | first time domain resource quantity for a non-latency |
| | latency time | | sensitive service. |
| | resource) | | |
| B22 + L - | reserved | N-L-22 | Reserved and set to 1. |
| BN − 1 | | | |

TABLE 6
First user field format for an MU-MIMO allocation

| | | Number of | |
|---|---|---|---|
| Bit | Subfield | subfields | Description |
| B0-B10 | STA-ID | 11 | For meaning, refer to Table 4; however, its |
| | | | implementation is not specifically limited. |
| B11-B14 | MCS | 4 | For meaning, refer to Table 4; however, its |
| | | | implementation is not specifically limited. |
| B15 | coding | 1 | For meaning, refer to Table 4; however, its |
| | | | implementation is not specifically limited. |
| B16-B21 | spatial | 6 | For meaning, refer to Table 4; however, its |
| | configuration | | implementation is not specifically limited. |
| B22- | low latency | L | The low latency preemption time resource is used to |
| B21 + L | preemption | | indicate a first time domain resource quantity for a |
| | time resource | | latency sensitive service; |
| | (or non-low | | the non-low latency time resource is used to indicate a |
| | latency time | | first time domain resource quantity for a non-latency |
| | resource) | | sensitive service. |
| B22 + L - | reserved | N-L-22 | Reserved and set to 1. |
| BN − 1 | | | |

It should be noted that the UHR feature information carried by the first user field shown in FIG. 9 may further include a parameter corresponding to the low power listening mode. For example, a quantity of bits N in the first user field being 30 is used as an example, and the first user field carrying the fundamental information of the first user, the first time domain resource quantity (the low latency preemption time resource/non-low latency time resource is used as an example), and the parameter corresponding to the low power listening mode (the high power bandwidth is used as an example) may be as shown in Table 7 or Table 8. The fundamental information may occupy the first 22 bits of the first user field, the low latency preemption time resource/non-low latency time resource field may occupy 6 bits located after the fundamental information, and the high power bandwidth field may occupy remaining 2 bits. For example, a value of the high power bandwidth field being 0 may represent 40 MHz; a value of the high power bandwidth field being 1 may represent 80 MHz; a value of the high power bandwidth field being 2 may represent 160 MHz; a value of the high power bandwidth field being 3 may represent 320 MHz. It should be noted that the first user field in embodiments of this application may be formed by arranging and combining one or more subfields in Table 7 or Table 8. The arrangement and combination of subfields shown in Table 7 or Table 8 is one of multiple implementations of the first user field and constitutes no limitations on the first user field.

TABLE 7
First user field format for a non-MU-MIMO allocation

| | | Number of | |
|---|---|---|---|
| Bit | Subfield | subfields | Description |
| B0-B10 | STA-ID | 11 | For meaning, refer to Table 3; however, its |
| | | | implementation is not specifically limited. |
| B11-B14 | MCS | 4 | For meaning, refer to Table 3; however, its |
| | | | implementation is not specifically limited. |
| B15 | reserved | 1 | For meaning, refer to Table 3; however, its |
| | | | implementation is not specifically limited. |
| B16-B19 | NSS | 4 | For meaning, refer to Table 3; however, its |
| | | | implementation is not specifically limited. |
| B20 | beamformed | 1 | For meaning, refer to Table 3; however, its |
| | | | implementation is not specifically limited. |
| B21 | coding | 1 | For meaning, refer to Table 3; however, its |
| | | | implementation is not specifically limited. |
| B22-B27 | low latency | 6 | The low latency preemption time resource is used to |
| | preemption | | indicate a first time domain resource quantity for a |
| | time | | latency sensitive service; the non-low latency time |
| | resource (or | | resource is used to indicate a first time domain resource |
| | non-low | | quantity for a non-latency sensitive service. |
| | latency time | | |
| | resource) | | |
| B28-B29 | high power | 2 | Bandwidth for transitioning from low power |
| | bandwidth | | listening to high power, where |
| | | | 0 represents 40 MHz, value 1 represents 80 MHz, value |
| | | | 2 represents 160 MHz, value 3 represents 320 MHz. |

TABLE 8
First user field format for an MU-MIMO allocation

| | | Number of | |
|---|---|---|---|
| Bit | Subfield | subfields | Description |
| B0-B10 | STA-ID | 11 | For meaning, refer to Table 4; however, its |
| | | | implementation is not specifically limited. |
| B11-B14 | MCS | 4 | For meaning, refer to Table 4; however, its |
| | | | implementation is not specifically limited. |
| B15 | coding | 1 | For meaning, refer to Table 4; however, its |
| | | | implementation is not specifically limited. |
| B16-B21 | spatial | 6 | For meaning, refer to Table 4; however, its |
| | configuration | | implementation is not specifically limited. |
| B22-B27 | low latency | 6 | The low latency preemption time resource is used to |
| | preemption | | indicate a first time domain resource quantity for a |
| | time resource | | latency sensitive service; the non-low latency time |
| | (or non-low | | resource is used to indicate a first time domain resource |
| | latency time | | quantity for a non-latency sensitive service. |
| | resource) | | |
| B28-B29 | high power | 2 | Bandwidth for transitioning from low power |
| | bandwidth | | listening to high power, where |
| | | | 0 represents 40 MHz, value 1 represents 80 MHz, |
| | | | value 2 represents 160 MHz, value 3 represents 320 MHz. |

As shown in FIG. 10, the first user field may alternatively be a field of an extra subfield newly added based on the user field in the UHR-SIG field, and UHR feature information may be carried in the newly added subfield. In FIG. 9, in an example in which the UHR feature information is a first time domain resource quantity, the first time domain resource quantity may be determined based on a second field in the first user field. For example, the first user field may include a user field (namely, a second user field) in the UHR-SIG field and a user extension field (namely, a third user field). A quantity of bits in the user field and a quantity of bits in the user extension field may be the same, both are 22 bits. The user extension field may be located after the user field and adjacent to the user field. The user field may be used to carry fundamental information of the first user, such as STA-ID, MCS, quantity of spatial streams, encoding scheme, enabled beamforming parameter, or the like of the first user. A structure of the user field may be as shown in Table 3 or Table 4. The user extension field may then be used to carry UHR feature information. For example, a structure of the user extension field may be as shown in Table 9. The first 11 bits of the user extension field may be used to carry STA-ID, and the STA-ID is the same as STA-ID carried in the first 11 bits of the user field. Moreover, the user extension field and the user field may be located in a same user encoding block. In the user extension field, the L bits located after the STA-ID may be used to carry the low latency preemption time resource/non-low latency time resource field. The low latency preemption time resource/non-low latency time resource field, namely, the second field, may be used to carry a quantity of OFDM symbols occupied by a low latency service/non-low latency service in the first time domain resource. A value of the low latency preemption time resource/non-low latency time resource field may be as described above and will not be repeated herein. Remaining bits of the user extension field may serve as reserved bits. It should be noted that the user extension field in embodiments of this application may be formed by arranging and combining one or more subfields in Table 9. The arrangement and combination of subfields shown in Table 9 is one of multiple implementations of the user extension field and constitutes no limitations on the user extension field.

TABLE 9
User extension field format

| | | Number of | |
|---|---|---|---|
| Bit | Subfield | subfields | Description |
| B0-B10 | STA-ID | 11 | Set to a value of the TXVECTOR parameter STA-ID. |
| B11- | low latency | L | The low latency preemption time resource is used to |
| B10 + L | preemption | | indicate a first time domain resource quantity for a |
| | time | | latency sensitive service; |
| | resource (or | | the non-low latency time resource is used to indicate a |
| | non-low | | first time domain resource quantity for a non-latency |
| | latency time | | sensitive service. |
| | resource) | | |
| B11 + L- | reserved | 11-L | Reserved and set to 1. |
| B21 | | | |

It should be noted that the UHR feature information carried by the first user field shown in FIG. 10 may further include a parameter corresponding to the low power listening mode. For example, the user extension field carrying the STA-ID of a first user, the first time domain resource quantity (the low latency preemption time resource/non-low latency time resource is used as an example), and the parameter corresponding to the low power listening mode (the high power bandwidth is used as an example) may be as shown in Table 10. The STA-ID of the first user may occupy the first 11 bits of the user extension field, the low latency preemption time resource/non-low latency time resource field may occupy 6 bits located after the STA-ID, the high power bandwidth field may occupy 2 bits located after the low latency preemption time resource/non-low latency time resource field, and the remaining 3 bits may serve as reserved bits. It should be noted that the user extension field in embodiments of this application may be formed by arranging and combining one or more subfields in Table 10. The arrangement and combination of subfields shown in Table 10 is one of multiple implementations of the user extension field and constitutes no limitations on the user extension field.

TABLE 10
User extension field format

| | | Number of | |
|---|---|---|---|
| Bit | Subfield | subfields | Description |
| B0-B10 | STA-ID | 11 | Set to a value of the TXVECTOR parameter STA-ID. |
| B11-B16 | low latency | 6 | The low latency preemption time resource is used to |
| | preemption | | indicate a first time domain resource quantity for a |
| | time | | latency sensitive service; the non-low latency time |
| | resource (or | | resource is used to indicate a first time domain resource |
| | non-low | | quantity for a non-latency sensitive service. |
| | latency time | | |
| | resource) | | |
| B17-B18 | high power | 2 | Bandwidth for transitioning from low power listening to |
| | bandwidth | | high power, where |
| | | | 0 represents 40 MHz, value 1 represents 80 MHz, value |
| | | | 2 represents 160 MHz, value 3 represents 320 MHz. |
| B19-B21 | reserved | 3 | Bandwidth for transitioning from low power listening to |
| | | | high power, where 0 represents 40 MHz, value 1 |
| | | | represents 80 MHz, value 2 represents 160 MHz, value 3 |
| | | | represents 320 MHz. |

In addition, the UHR-SIG field shown in FIG. 10 includes a UHR-SIG content channel. As mentioned above, when OFDMA transmission and multi-user non-OFDMA transmission are performed for a UHR MU PPDU larger than 20 MHz, its UHR-SIG field may include a plurality of UHR-SIG content channels. Therefore, the UHR-SIG field shown in FIG. 10 may alternatively include a plurality of UHR-SIG content channels. If the UHR-SIG field shown in FIG. 10 includes a plurality of UHR-SIG content channels, user specific fields of different UHR-SIG content channels have different content. For example, part of UHR-SIG content channels may include a user extension field, while the remaining part of UHR-SIG content channels may not include a user extension field. For instance, when a 40-MHz UHR MU PPDU performs OFDMA transmission, a UHR-SIG content channel 1 may include a user extension field; and a UHR-SIG content channel 2 may not include a user extension field.

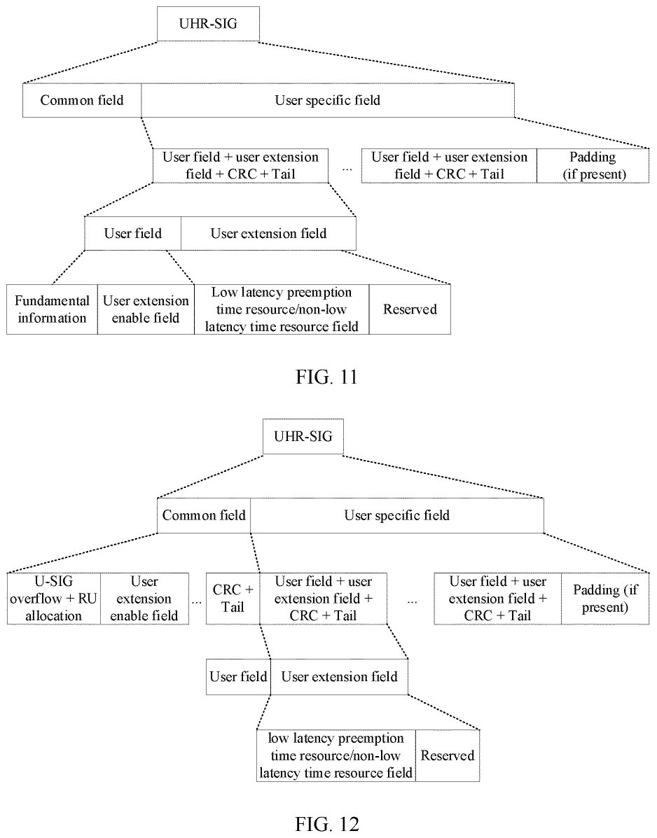

As mentioned above, when the first user field includes a third user field, the first PPDU may further include a first field to indicate whether the first user field carries the third user field. The first user field shown in FIG. 10 is used as an example to illustrate an example of the first field in the wireless communication method in embodiments of this application with reference to FIGS. 11 and 12. For ease of understanding, the first field may be a user extension enable field.

As shown in FIG. 11, the first field (the user extension enable field is used as an example) may be located in the second user field (the user field is used as an example) of the first user field, indicating whether one or more third user fields (the user extension field is used as an example) for a same STA immediately follow the user field. For example, a format of the user field may be as shown in Table 11, and the user extension enable field may occupy the 15th bit of the user field. Different values of the user extension enable field indicate different meanings. For example, a value of the user extension enable field being 0 may indicate that there is a user extension field, that is, the STA needs to attempt to continue searching for one or more extra user extension fields matching its STA-ID. A value of the user extension enable field being 1 may indicate that there is no user extension field. It should be noted that the user field in embodiments of this application may be formed by arranging and combining one or more subfields is Table 11. The arrangement and combination of subfields shown in Table 11 is one of multiple implementations of the user field and constitutes no limitations on the user field.

TABLE 11
User field format for non-MU-MIMO

| | | Number of | |
|---|---|---|---|
| Bit | Subfield | subfields | Description |
| B0-B10 | STA-ID | 11 | For meaning, refer to Table 3; however, its |
| | | | implementation is not specifically limited. |
| B11-B14 | MCS | 4 | For meaning, refer to Table 3; however, its |
| | | | implementation is not specifically limited. |
| B15 | user | 1 | Indicates that one or more extra user extension fields for |
| | extension | | a same STA immediately follow this user field. A value |
| | enable | | of 0 indicates there is a user extension field; a value of 1 |
| | | | indicates there is no user extension field. |
| B16-B19 | NSS | 4 | For meaning, refer to Table 3; however, its |
| | | | implementation is not specifically limited. |
| B20 | beamformed | 1 | For meaning, refer to Table 3; however, its |
| | | | implementation is not specifically limited. |
| B21 | coding | 1 | For meaning, refer to Table 3; however, its |
| | | | implementation is not specifically limited. |

As shown in FIG. 12, the first field may alternatively be located in a common field of a first PPDU, indicating whether the user specific field corresponding to the common field includes one user field and one or more extra user extension fields for a same STA. For example, a format of the common field may be as shown in Table 12, where the user extension enable field may occupy the 13^{th} bit of the common field. Different values of the user extension enable field indicate different meanings. For example, a value of the user extension enable field being 0 may indicate that there is a user extension field, that is, the STA needs to attempt to continue searching for one or more extra user extension fields matching its STA-ID. A value of the user extension enable field being 1 may indicate that there is no user extension field. It should be noted that the common field in embodiments of this application may be formed by arranging and combining one or more subfields is Table 12. The arrangement and combination of subfields shown in Table 12 is one of multiple implementations of the common field and constitutes no limitations on the common field.

TABLE 12
Format of common field

| | | Number of | |
|---|---|---|---|
| Bit | Subfield | subfields | Number of bits per subfield |
| B0-B3 | spatial reuse | 1 | For meaning, refer to Table 1; however, its |
| | | | implementation is not specifically limited. |
| B4-B5 | GI + LTF size | 1 | For meaning, refer to Table 1; however, its |
| | | | implementation is not specifically limited. |
| B6-B8 | Number of | 1 | For meaning, refer to Table 1; however, its |
| | UHR-LTF symbols | | implementation is not specifically limited. |
| B9 | LDPC extra | 1 | For meaning, refer to Table 1; however, its |
| | symbol segment | | implementation is not specifically limited. |
| B10-B11 | Pre-FEC padding | 1 | For meaning, refer to Table 1; however, its |
| | factor | | implementation is not specifically limited. |
| B12 | PE disambiguity | 1 | For meaning, refer to Table 1; however, its |
| | | | implementation is not specifically limited. |
| B13 | user extension | 1 | Indicates whether the user specific field |
| | enable | | corresponding to the common field includes one user |
| | | | field and one or more extra user extension fields for a |
| | | | same STA. A value of 0 indicates there is a user |
| | | | extension field; a value of 1 indicates there is no user |
| | | | extension field. |
| B14-B16 | disregard | 1 | For meaning, refer to Table 1; however, its |
| | | | implementation is not specifically limited. |
| B17- | RU allocation-A | N | For meaning, refer to Table 1; however, its |
| B16 + 9N | | | implementation is not specifically limited. |
| B17 + 9N- | CRC | 1 | For meaning, refer to Table 1; however, its |
| B20 + 9N | | | implementation is not specifically limited. |
| B21 + 9N- | tail | 1 | For meaning, refer to Table 1; however, its |
| B26 + 9N | | | implementation is not specifically limited. |
| B27 + 9N- | RU allocation-B | M | For meaning, refer to Table 1; however, its |
| B26 + 9N + 9M | | | implementation is not specifically limited. |
| B27 + 9N + 9- | CRC | 0 or 1 | For meaning, refer to Table 1; however, its |
| B30 + 9N + 9M | | | implementation is not specifically limited. |
| B31 + 9N + 9- | tail | 0 or 1 | For meaning, refer to Table 1; however, its |
| B36 + 9N + 9M | | | implementation is not specifically limited. |

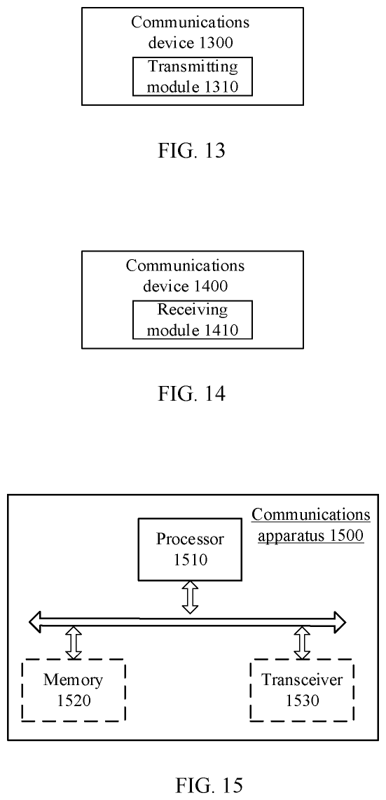

The method embodiments of this application are described above in detail with reference to FIG. 1 to FIG. 12. Apparatus embodiments of this application are described below in detail with reference to FIG. 13 to FIG. 15. It should be understood that the descriptions of the method embodiments correspond to descriptions of the apparatus embodiments, and therefore, for parts that are not described in detail, reference may be made to the foregoing method embodiments.

FIG. 13 is a schematic diagram of a structure of a communications device according to an embodiment of this application. The communications device 1300 shown in FIG. 13 is a first device and may include a transmitting module 1310. The transmitting module 1310 may be used to transmit a first PPDU to a second device. The first PPDU may include a first user field of a first user, and the first user field carries UHR feature information.

In embodiments of this application, the communications device 1300 may be used to perform some or all of the method steps executed by the first device in the foregoing method embodiments. For example, the communications device 1300 may be used to perform some or all of the method steps executed by the first device in the methods described above with reference to FIGS. 7 to 12. The communications device 1300 includes units or modules for performing the method steps corresponding to the foregoing FIGS. 7 to 12. The method procedures have been described in detail in the foregoing implementations. The modules in this embodiment have the same functions or perform the same steps, which are known by those skilled in the art, and will not be repeated herein. The text descriptions corresponding to FIGS. 7 to 12 may be incorporated into this example, corresponding to the modules in the communications device 1300.

FIG. 14 is a schematic diagram of a structure of a communications device according to another embodiment of this application. The communications device 1400 shown in FIG. 14 is a second device and may include a receiving module 1410. The receiving module 1410 may be used to receive a first PPDU transmitted by a first device. The first PPDU may include a first user field of a first user, and the first user field carries UHR feature information.

In embodiments of this application, the communications device 1400 may be used to perform some or all of the method steps executed by the second device in the foregoing method embodiments. For example, the communications device 1400 may be used to perform some or all of the method steps executed by the second device in the methods described above with reference to FIGS. 7 to 12. The communications device 1400 includes units or modules for performing the method steps corresponding to the foregoing FIGS. 7 to 12. The method procedures have been described in detail in the foregoing implementations. The modules in this embodiment have the same functions or perform the same steps, which are known by those skilled in the art, and will not be repeated herein. The text descriptions corresponding to FIGS. 7 to 12 may be incorporated into this example, corresponding to the modules in the communications device 1400.

FIG. 15 is a schematic diagram of a structure of a communications apparatus according to an embodiment of this application. Dashed lines in FIG. 15 indicate that a unit or module is optional. The apparatus 1500 may be configured to implement the methods described in the foregoing method embodiments. The apparatus 1500 may be a chip, a terminal device, or a network device.

The apparatus 1500 may include one or more processors 1510. The processor 1510 may support the apparatus 1500 in implementing the methods described in the foregoing method embodiments. The processor 1510 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program, where the program may be executed by the processor 1510, to cause the processor 1510 to execute the methods described in the method embodiments. The memory 1520 may be separated from or integrated into the processor 1510.

The apparatus 1500 may further include a transceiver 1530. The processor 1510 may communicate with another device or chip by using the transceiver 1530. For example, the processor 1510 may transmit data to and receive data from another device or chip through the transceiver 1530.

An embodiment of this application further provides a computer-readable storage medium for storing a program. The computer-readable storage medium may be applied to a terminal or a network device provided in embodiments of this application, and the program causes a computer to execute the methods executed by a communications device in various embodiments of this application.

An embodiment of this application further provides a computer program product. The computer program product includes a program. The computer program product may be applied to the terminal or the network device provided in embodiments of this application, and the program causes a computer to execute the methods executed by a communications device in various embodiments of this application.

An embodiment of this application further provides a computer program. The computer program may be applied to the terminal or the network device provided in embodiments of this application, and the computer program causes a computer to execute the methods executed by the communications device in various embodiments of this application.

It should be understood that all or some of functions of the communications device in this application may alternatively be implemented by software functions running on hardware, or by virtualization functions instantiated on a platform (for example, a cloud platform).

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefining” or “pre-configuring” may be implemented by pre-storing corresponding code, tables, or other forms that may be used to indicate related information in devices (for example, including a terminal device and a network device), and a specific implementation thereof is not limited in this application. For example, being predefined may refer to being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” describes merely an association relationship between associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, the “include” may refer to direct inclusion, or may refer to indirect inclusion. Optionally, the term “include” mentioned in embodiments of this application may be replaced with “indicate” or “be used to determine”. For example, A including B may be replaced with that A indicates B, or A is used to determine B.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments. In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
transmitting, by a first device, a first physical layer protocol data unit (PPDU) to a second device, wherein the first PPDU comprises a first user field of a first user, and the first user field carries ultra-high reliability (UHR) feature information.

2. The method according to claim 1, wherein the first PPDU is an ultra-high reliability multi-user physical layer protocol data unit (UHR MU PPDU).

3. The method according to claim 2, wherein the UHR MU PPDU comprises a pre-UHR modulated field and a UHR modulated field.

4. The method according to claim 3, wherein the pre-UHR modulated field comprises a non-high-throughput long-training field (L-STF), a non-high-throughput long-training field (L-LTF), a non-high-throughput-signal field (L-SIG), a repeated non-high-throughput-signal field (RL-SIG), a universal-signal field (U-SIG), and an ultra-high reliability signal field (UHR-SIG).

5. The method according to claim 3, wherein the UHR modulated field comprises a UHR short training field (UHR-STF), a UHR long training field (UHR-LTF), a data field, and a packet extension field (PE).

6. The method according to claim 4, wherein the UHR-SIG comprises a UHR-SIG content channel, and
in a case that a bandwidth of the UHR MU PPDU is 20 MHz, the UHR-SIG field comprises one UHR-SIG content channel; or
in a case that a bandwidth of the UHR MU PPDU is 40 MHz or 80 MHz, and orthogonal frequency division multiple access (OFDMA) transmission or multi-user non-orthogonal frequency division multiple access (non-OFDMA) transmission is performed, the UHR-SIG field comprises two UHR-SIG content channels; or
in a case that a bandwidth of the UHR MU PPDU is greater than or equal to 160 MHz, and orthogonal frequency division multiple access (OFDMA) transmission or multi-user non-orthogonal frequency division multiple access (non-OFDMA) transmission is performed, the UHR-SIG field comprises two UHR-SIG content channels per 80 MHz frequency sub-block.

7. The method according to claim 6, wherein in a case that the bandwidth of the UHR MU PPDU for the OFDMA transmission is greater than 80 MHz, the UHR-SIG content channel in each 80 MHz frequency sub-block is allowed to carry different information.

8. The method according to claim 6, wherein the UHR-SIG content channel in the UHR-SIG field comprises a common field and a user-specific field, and a format of content channel in the UHR-SIG field is the same as a format of content channel in an EHT-SIG field.

9. The method according to claim 1, wherein the first user field further carries fundamental information of the first user, and the fundamental information of the first user comprises one or more of the following: station identifier (STA-ID), modulation and coding scheme (MCS), quantity of spatial streams, encoding scheme, or beamforming enablement.

10. The method according to claim 1, wherein a number of bits of the first user field is greater than 22 bits.

11. The method according to claim 4, wherein the first user field is located in the UHR-SIG field of the UHR MU PPDU.

12. A wireless communication method, comprising:
receiving, by a second device, a first PPDU transmitted by a first device, wherein the first PPDU comprises a first user field of a first user, and the first user field carries UHR feature information.

13. The method according to claim 12, wherein the first PPDU is an ultra-high reliability multi-user physical layer protocol data unit (UHR MU PPDU).

14. The method according to claim 13, wherein the UHR MU PPDU comprises a pre-UHR modulated field and a UHR modulated field.

15. The method according to claim 14, wherein the pre-UHR modulated field comprises a non-high-throughput long-training field (L-STF), a non-high-throughput long-training field (L-LTF), a non-high-throughput-signal field (L-SIG), a repeated non-high-throughput-signal field (RL-SIG), a universal-signal field (U-SIG), and an ultra-high reliability signal field (UHR-SIG).

16. The method according to claim 14, wherein the UHR modulated field comprises a UHR short training field (UHR-STF), a UHR long training field (UHR-LTF), a data field, and a packet extension field (PE).

17. The method according to claim 15, wherein the UHR-SIG comprises a UHR-SIG content channel, and
in a case that a bandwidth of the UHR MU PPDU is 20 MHz, the UHR-SIG field comprises one UHR-SIG content channel; or
in a case that a bandwidth of the UHR MU PPDU is 40 MHz or 80 MHz, and orthogonal frequency division multiple access (OFDMA) transmission or multi-user non-orthogonal frequency division multiple access (non-OFDMA) transmission is performed, the UHR-SIG field comprises two UHR-SIG content channels; or
in a case that a bandwidth of the UHR MU PPDU is greater than or equal to 160 MHz, and orthogonal frequency division multiple access (OFDMA) transmission or multi-user non-orthogonal frequency division multiple access (non-OFDMA) transmission is performed, the UHR-SIG field comprises two UHR-SIG content channels per 80 MHz frequency sub-block.

18. The method according to claim 17, wherein in a case that the bandwidth of the UHR MU PPDU for the OFDMA transmission is greater than 80 MHz, the UHR-SIG content channel in each 80 MHz frequency sub-block is allowed to carry different information.

19. The method according to claim 17, wherein the UHR-SIG content channel of the UHR-SIG field comprises a common field and a user-specific field, and a format of the UHR-SIG field is the same as that of an extremely high throughput signal field (EHT-SIG).

20. A communications device, wherein the communications device is a first device and comprises a memory and a processor, the memory is configured to store a program, and the processor is configured to invoke the program in the memory to cause the communications device to execute following operation:
transmitting a first physical layer protocol data unit (PPDU) to a second device, wherein the first PPDU comprises a first user field of a first user, and the first user field carries ultra-high reliability (UHR) feature information.
